(19) United States
(12) Patent Application Publication
(10) Pub. No.: US 2024/0111883 A1
(43) Pub. Date: Apr. 4, 2024

(54) IMPROVED COALESCENCE OF ROLES FOR ROLE-BASED ACCESS CONTROL

(71) Applicant: ForgeRock, Inc., San Francisco, CA (US)

(72) Inventors: Dennis Karl Wilhelm HAAKE, Oslo (NO); Sanjay RALLAPALLY, Dublin, CA (US); Ivan HUGHES, Jr., Fulshear, TX (US)

(73) Assignee: ForgeRock, Inc., San Francisco, CA (US)

(21) Appl. No.: 17/956,734

(22) Filed: Sep. 29, 2022

(51) Int. Cl. G06F 21/62

(52) U.S. Cl. CPC G06F 21/6218

(57) ABSTRACT

The disclosed technology teaches a method of identifying roles to coalesce. The disclosed role coalescence engine includes compiling roles from an enterprise database and associated role features respective to each role (such as members who belong to a particular role or access privileges assigned to a particular role), computing a similarity measure between pairs of roles with respect to a single role feature, and clustering role pairs based on the similarity measure. The method further includes generating a cluster visualization based on the clustered role pairs and causing display of the cluster visualization to a user with controls for selecting a particular cluster of the cluster visualization. Coalescence of role databases results in improved security for identity governance and administration tools by reducing unauthorized or inappropriate access.

### RELATED APPLICATIONS

This application is related to the following applications which are incorporated by reference herein for all purposes:

U.S. application Ser. No. 17/559,911, titled “Role Mining Proximity Analysis for Improved Role-Based Access Control,” filed 22 Dec. 2021 (Attorney Docket. No. FORG 1016-3) which claims priority to and the benefit of U.S. Application No. 63/270,761 filed 22 Oct. 2021 (Attorney Docket. No. FORG 1016-2) and U.S. Application No. 63/255,319 filed 13 Oct. 2021 (Attorney Docket. No. FORG 1016-1); and

U.S. application Ser. No. 15/900,475, titled “System for Controlling Access to a Plurality of Target Systems and Applications,” filed 20 Feb. 2018, now U.S. Pat. No. 10,708,274, issued 7 Jul. 2020 (Attorney Docket. No. FORG 1006-1); and

U.S. application Ser. No. 16/016,154, titled “System for Controlling Access to a Plurality of Target Systems and Applications,” now U.S. Pat. No. 10,686,795, issued 16 Jun. 2020 (Attorney Docket. No. FORG 1006-2), which is a continuation in part of U.S. Ser. No. 15/900,475.

### FIELD OF THE TECHNOLOGY DISCLOSED

The technology disclosed relates generally to processes or apparatus for increasing a system's extension of protection of system hardware, software, or data from maliciously caused destruction, unauthorized modification, or unauthorized disclosure. The technology disclosed more specifically relates to coalescing redundant or outdated roles within an enterprise to reduce over-provisioning of access, thereby reducing risk exposure. In particular, the technology disclosed utilizes artificial intelligence to process role-associated data to identify similar roles and displays cluster analysis tools for examining and coalescing similar roles.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Delegation, revocation, and supervision of user access provisioning through role based access control (RBAC) is intended to streamline identity and access management. RBAC tools are intended to allow for access permissions that appropriately reflect a particular employee's job responsibilities to be provisioned automatically. Ideally, RBAC should result in reduced over-provisioning of access, decreased risk exposure, and expedited identification of inappropriate access. Information security has invested deeply in RBAC; however, very little success has been achieved.

Drawbacks such as human bias introduced in establishing roles and permissions, the large volume of data to be analyzed, and the dynamic nature of the access landscape contribute to failures in RBAC implementation.

An opportunity arises for identifying candidate roles within an enterprise for coalescence by computing a similarity measure between pairs of roles with respect to a particular role association entity and utilizing hierarchical clustering dendrogram insights that allow a user to determine important enterprise-specific role-based access knowledge.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 shows an architectural level diagram of a system for a role coalescence engine, according to one embodiment of the disclosed technology.

FIG. 2 shows a block diagram of a system for identifying candidate roles to coalesce by effectively ranking similar roles as candidates.

FIG. 3A shows a flow diagram of a method for identifying candidate roles to coalesce by effectively ranking similar roles as candidates.

FIG. 3B shows a flow diagram of a method for identifying similar members in the intersection of two roles.

FIG. 3C shows a flow diagram of a method for identifying similar entitlements in the intersection of two roles.

FIG. 4A illustrates the membership and entitlement features associated with a particular role.

FIG. 4B shows an entity relationship diagram illustrating the structure and relationships of a role, according to one embodiment of the disclosed technology.

FIG. 5A illustrates an example calculation of the Jaccard similarity index.

FIG. 5B illustrates an example calculation of the Sorensen-Dice coefficient.

FIG. 5C illustrates a comparison of Euclidean distance and Hamming distance.

FIG. 6A illustrates a hierarchical dendrogram generated from clustered role pair intersections.

FIG. 6B is a segment of a dendrogram with a few branches and leaves.

FIG. 6C displays subsets of data from the total similarity and clustering data.

FIG. 7A illustrates an example graphical user interface for selection of roles within a role coalescence engine.

FIG. 7B illustrates an example graphical user interface for coalescence criteria, and an example role analysis, within a role coalescence engine.

FIG. 7C illustrates an example graphical user interface for cluster visualizations within a role coalescence engine.

FIG. 7D illustrates an example graphical user interface for drilling down on a particular cluster within a cluster visualization.

FIG. 8 shows an example computer system that can be used to implement the technology disclosed.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Identity governance and administration encompass delegation, revocation, and supervision of provisioning for user access to databases, files structures and other computing resources. Administrators assign roles with associated privileges to users. The privileges govern access to data elements and process controls found in databases, file structures and other secure processes.

Enterprises suffer so-called role explosion due to redundant and outdated roles. This is a widely recognized problem that consultants offer to solve, often with disappointing results. Oracle, for instance, offers the role coalescence tool Oracle Identity Role Intelligence (OIRI). There is much room for improvement. A role-based Autonomous Identity (AI) based access control (AIBAC) system, is disclosed in U.S. patent application Ser. No. 17/559,911, which will be assigned to Applicant in due course. The AIBAC system discovers role-based access patterns across the organization and recommends consolidated role structures to reduce enterprise security risks. This application takes a different approach.

To address such issues, the technology disclosed detects candidate roles within a role database for coalescence. Through an interactive display, it allows a user, such as a security administrator, to efficiently identify superfluous roles within the enterprise and improving access security.

A robust role coalescence engine is disclosed. This tool provides readily interpretable role mining results. This technology graphically depicts evaluations of role similarity. Users interact with identified candidates for role coalescence. A user can leverage the similarity evaluations via an interactive data visualization process to specify coalescence.

Roles are compiled with corresponding features such as membership, entitlements, and supervisor. The roles can be compiled either directly, from the enterprise role structure, or from a coalesced role list generated by role mining. Role features can include a membership list comprising all members assigned to a specific role and a list of entitlements or access privileges assigned to a particular role. The method calculates similarity measures for the role features between pairs of roles, generating measures such as Jaccard similarity, Hamming distance, or a Sorenson-Dice coefficient. Similarity measures can be expressed as distances or converted to distances. Clustering is applied.

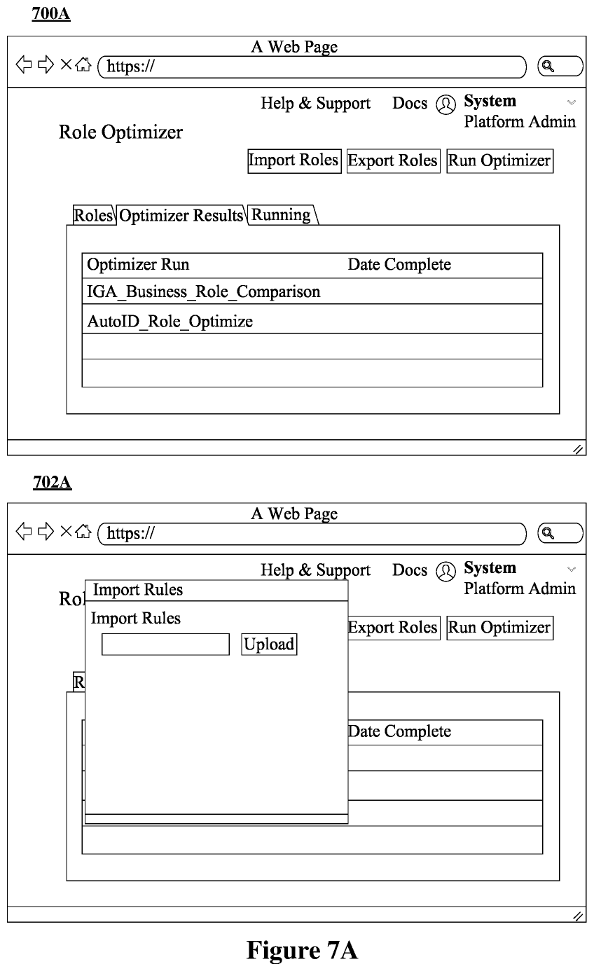

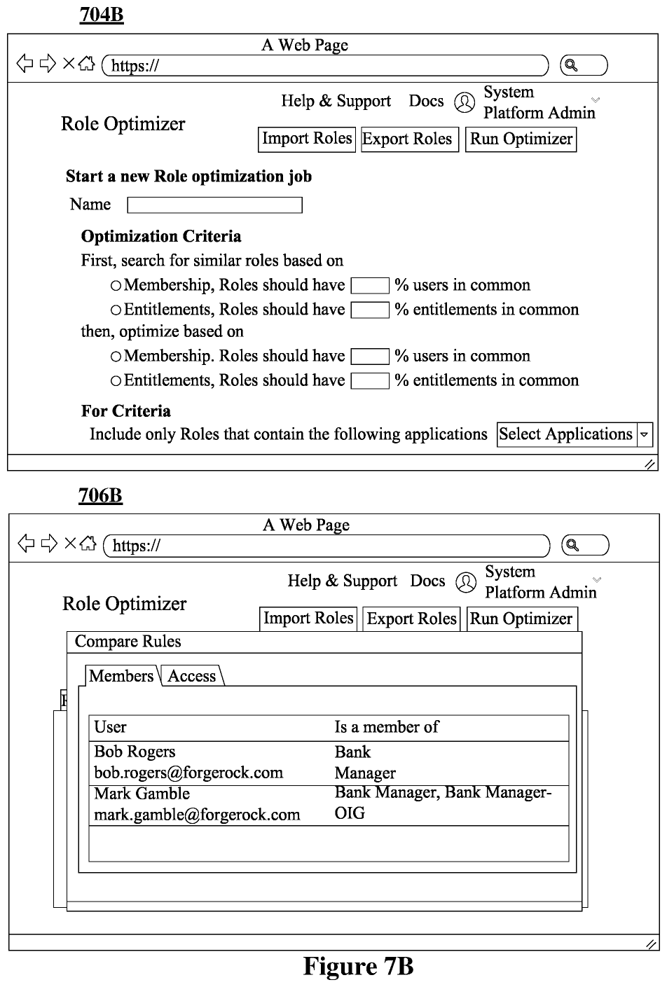

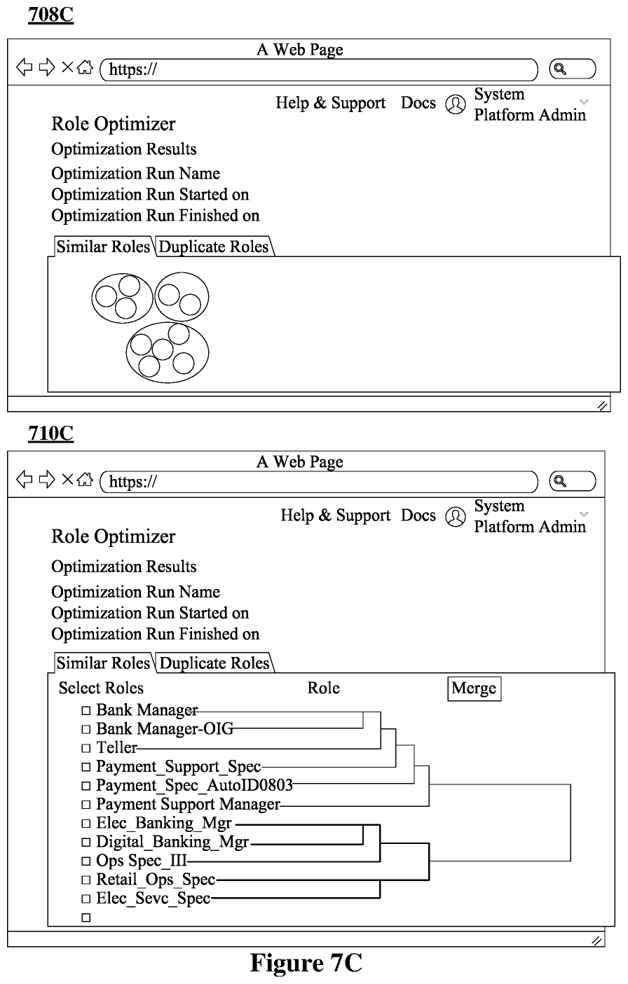

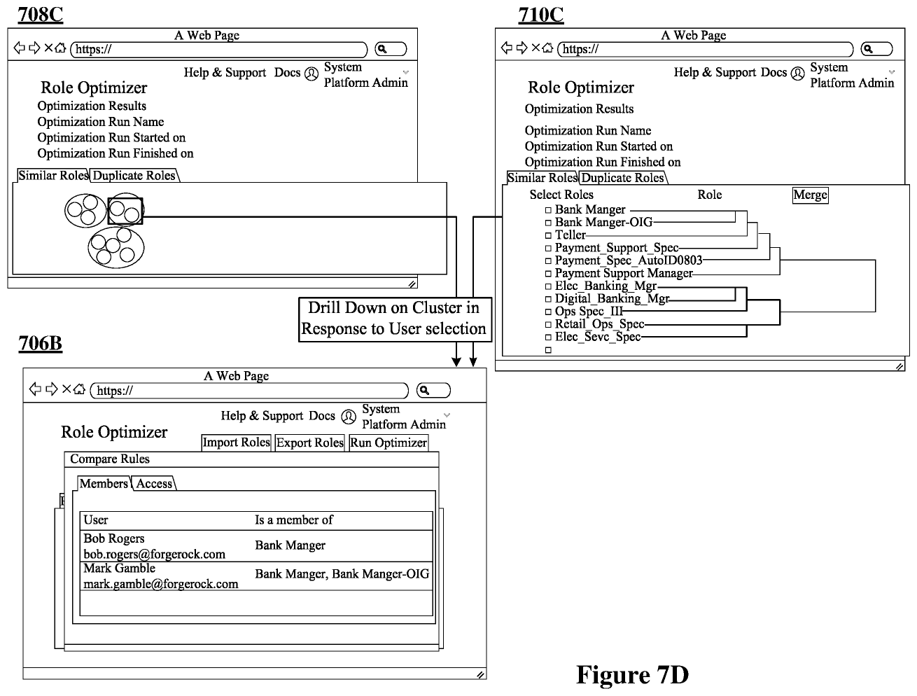

Role pairs can then be clustered using hierarchical clustering. The hierarchy of clusters can be graphically presented in a cluster visualization such as a dendrogram or circle packing graph, as illustrated in FIG. 7C. A hierarchy is typically several layers deep. Separate dendrograms depict clustering based on different features of a role, especially role membership and entitlements assigned to a role. Or, a combined measure can be applied to multiple features. Candidate roles for coalescence or even for detailed evaluation can be limited based on similarity or distance thresholds. In a dendrogram, multiple clusters appear as leaves from a shared branch. In a circle packing graph, each circle corresponds to a particular cluster, and circles are nested by hierarchy. Candidate roles for coalescence can be limited based on similarity, as illustrated by circle size (i.e., cluster size), color coding or other graphic.

The cluster visualization provides the security administrator with an interpretable, user-accessible form of data analysis that interactively leads to deeper exploration or coalescence of roles. A user may select a particular leaf or branch within a dendrogram or an interior or containing circle within a circle packing diagram to drill down the particular associated cluster(s). Selection causes display of a plurality of role features for roles in the selected clusters. The interactive display supports user comparison and selection for coalescence of roles that have similar role features.

The disclosure for this approach include the previously submitted “System for Controlling Access to a Plurality of Target Systems and Applications”, identified above and incorporated by reference.

The following section describes an environment for a role coalescence engine.

### Architecture

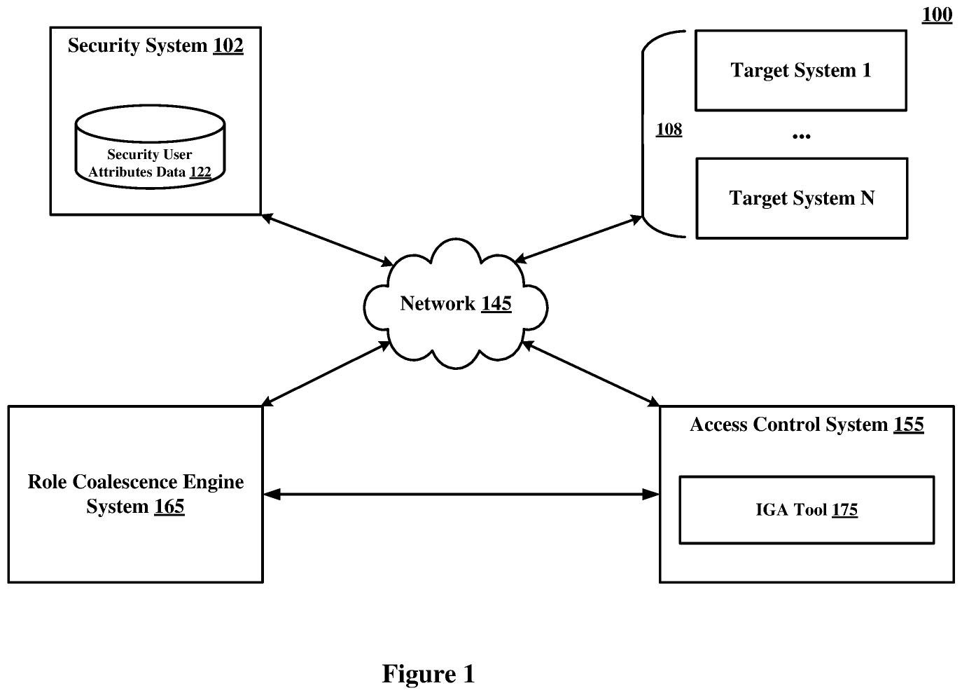

FIG. 1 shows an architectural level diagram of a system 100 for a role coalescence engine. Because FIG. 1 is an architectural diagram, certain details are intentionally omitted to improve the clarity of the description. The discussion of FIG. 1 is organized as follows. First, the elements of the figure are described, followed by their interconnections. Then, the use of the elements in the system is described in greater detail.

System 100 includes devices and systems that facilitate control of access to target systems, including security system 102, access control system 155, role coalescence engine system 165, and target systems one through N 108. Security system 102 facilitates specifying information associated with a user of the enterprise system, such as profile data. Security system 102 is operatable by a user associated with the enterprise, such as a security administrator. Exemplary profile data may include biographic information, such as a name, user identity, and address, along with enterprise-specific information such as an employment start date, title, grade level, department, manager name, reporting hierarchy, group, years of experience, physical location, and full-time/part-time designation. Target systems one through N 108 correspond to various computers located throughout the enterprise, configured to perform specific tasks, such as an enterprise resource planning (ERP) system, a customer relationship management (CRM) system, and a supply chain management (SCM) system. Each of the target systems one through N 108 may implement a form of access control to prevent unauthorized access.

Moreover, each of the target systems may host various applications, and each application may have its own form of access control to prevent unauthorized access. As used herein, access to a system and/or an application operating on the system is referred to as an entitlement or privilege. Access control system 155 responds to requests for access, coordinating authentication and consent gathering. Access control system 155 includes model 175 which builds association rules that can be levered to create functional roles. Various implementations of the technology disclosed may comprise distinct respective systems, such as an autonomous ID engine for AIBAC or other systems for RBAC. Role coalescence engine system 165 processes a list of roles and associated data such as associated membership or entitlements to a particular role to identify similar roles as candidates for coalescence.

In the interconnection of the elements of system 100, network 145 couples security system 102, role coalescence engine system 165, access control system 155, and target systems one through N 108 in communication. The communication path can be point-to-point over public and/or private networks. Communication can occur over various networks, e.g., private networks, VPN, MPLS circuit, or Internet, and can use appropriate application program interfaces (APIs) and data interchange forms, e.g., REST, JSON, XML, or SOAP. The communications can be encrypted in some implementations of the technology disclosed. In many implementations, the communication is over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX.

Further continuing with the description of system 100, the components of FIG. 1 are implemented by software running on varying computing devices. Example devices are a workstation, a server, a computing cluster, a blade server, a server farm, or any other data processing system or computing device. The engine can be communicably coupled to the databases via a different network connection.

While system 100 is described herein with reference to particular blocks, it is to be understood that the blocks are defined for convenience of description and are not intended to require a particular physical arrangement of component parts. Further, the blocks need not correspond to physically distinct components. To the extent that physical distinct components are used, connections between components can be wired and/or wireless as desired. The different elements or components can be combined into single software modules and multiple software modules can run on the same hardware.

Terminology in use in this document includes the following. “Entitlement” is a unit of privilege and can be fine-grained or coarse-grained. “Membership” comprises one or more users (“Members”) performing a particular role. “Role Features” associated with a particular role include entitlements, membership, supervisor, certification level, etc. “Assignment” is the relationship between user and entitlement, user and membership, or user with any additional role feature.

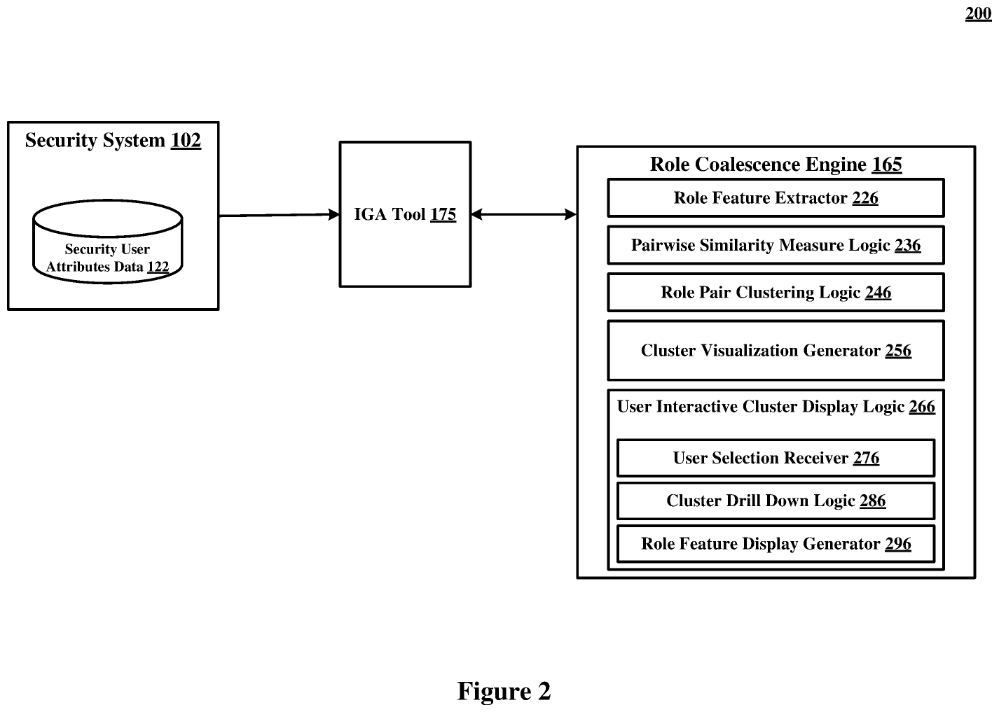

FIG. 2 expands upon the described blocks for FIG. 1. FIG. 2 shows a block diagram of a system 200 for identifying candidate roles to coalesce by effectively ranking similar roles as candidates. System 200 comprises security administrator 102, identity governance and administration tool 175, and role coalescence engine 165. The security system 102 further includes security user attributes data 122. When security system 102 requests access to a system or application, identity governance and administration tool 175 orchestrates centralized policy-based user identity management and access control, utilizing security user attributes data 122. Role coalescence engine 165 comprises role feature extractor 226, pairwise similarity measure logic 236, cluster visualization generator 256, and user interactive cluster display logic 266. Role feature extractor 226 compiles roles from identity governance and administration tool 175, as well as role assignments from security user attributes data 122. Pairwise similarity measure logic 236 measures similarity between a pair of roles with respect to a single role feature. In many implementations of the technology disclosed, the role feature is either entitlement or membership.

In one implementation of the technology disclosed, similarity is measured as a Jaccard similarity index value. In other implementations of the technology disclosed, similarity may be measured by a different distance metric such as a Sorensen-Dice coefficient, Euclidean distance, or Hamming distance. A person skilled in the art will recognize that these distance metrics are listed as educational examples and are not exclusive.

Following generation of a similarity measure by the pairwise similarity measure logic 236 for each possible role pair combination within all roles extracted by the role feature extractor 226, role pair clustering logic 246 clusters the plurality of role pairs. While role pair clustering logic 246 is described herein with reference to hierarchical agglomerative clustering, hierarchical divisive clustering can also be used without further altering the components of system 200. Cluster visualization generator 256 generates a dendrogram to visually interpret the clustering results produced by role pair clustering logic 246. A user or security administrator can interact with the dendrogram via user interactive cluster display logic 266. User interactive cluster display logic 266 comprises a user selection receiver 276, a cluster drill down logic 286, and a role feature display generator 296. User selection receiver 276 receives a selection of a particular branch from the user, prompting cluster drill down logic 286 to drill down the particular branch to observe additional data corresponding to the associated roles. Details and an example are described below.

The discussion now turns to role coalescence engine 165 in greater detail, wherein the similarity measurement and clustering procedures are described further.

### Role Coalescence Engine

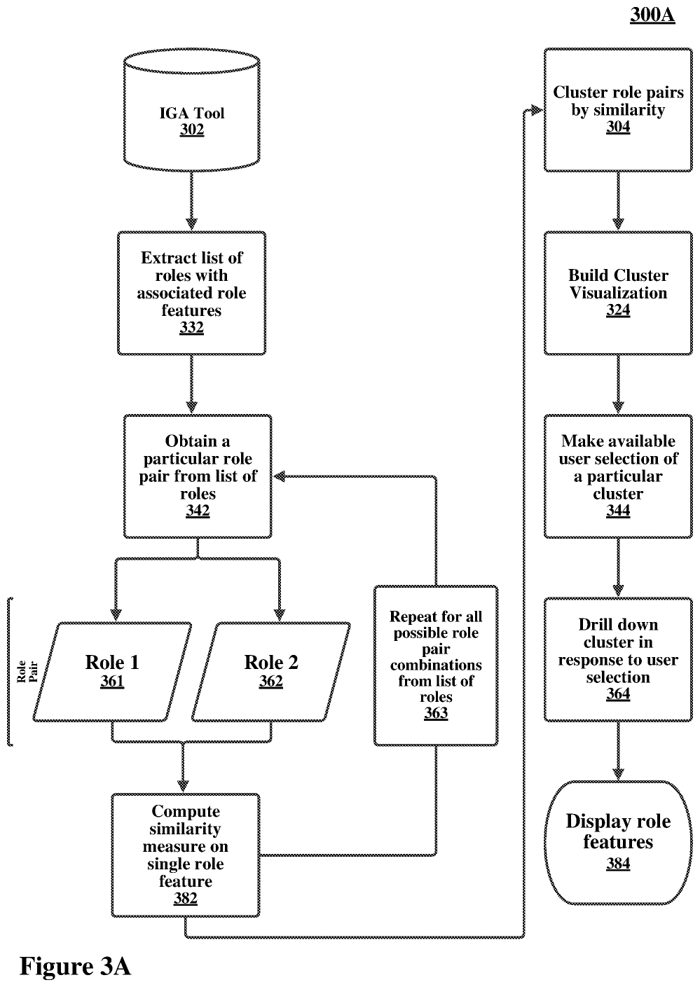

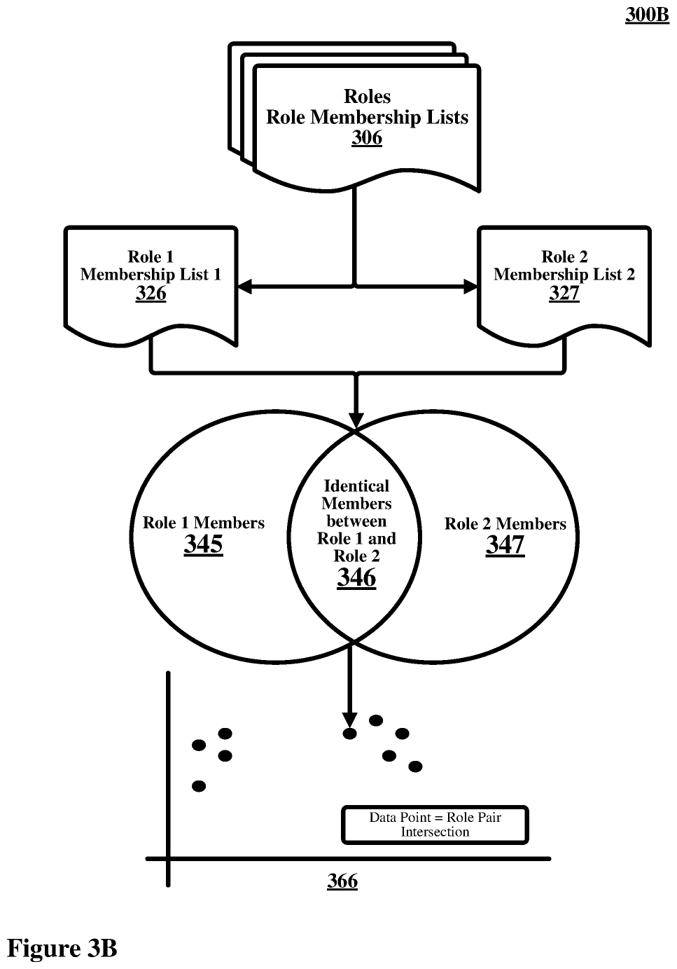

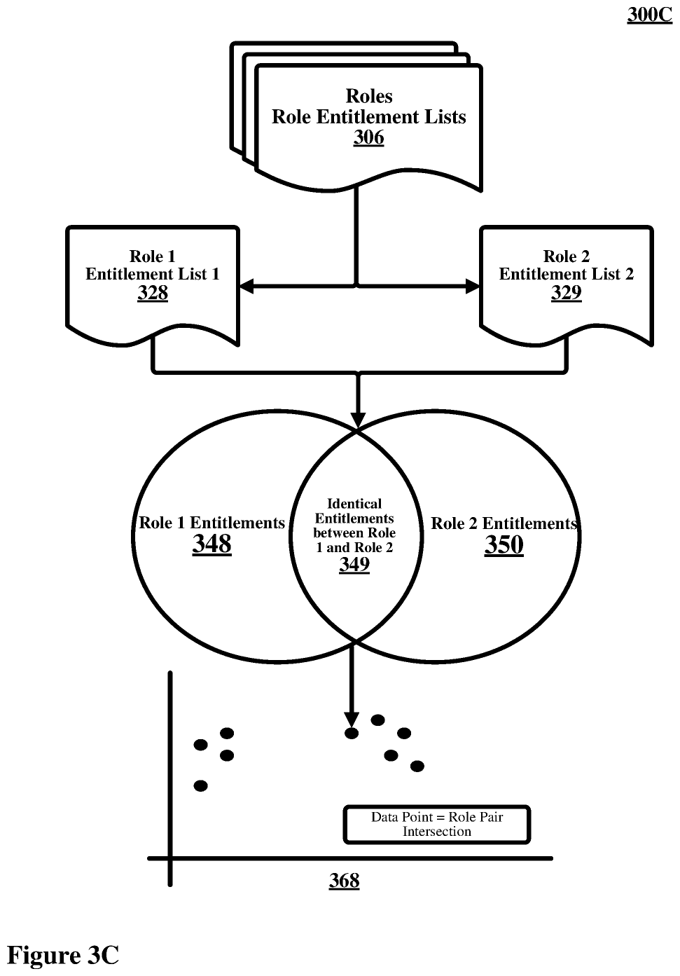

FIG. 3A shows a flow diagram 300A of a method for identifying candidate roles to coalesce that includes ranking similar roles that are candidates. An identity governance and administration tool 302 operates on information corresponding to roles and assigned role features, such as corresponding role entitlements or role memberships. Role feature extractor 226 performs step 332 to extract a list of roles with associated role features. In step 342, a particular role pair is obtained from the list of roles, wherein the role pair comprises a first role 361 and a second role 362. In step 382, a similarity measure is computed on a feature shared by the first and second roles, such as membership, for the role pair 361 and 362. As previously described, this similarity measure may be a variety of metrics. Examples of these metrics are described later in this document. Optionally, roles may undergo screening to discard role pairs that have weak similarity.

A plurality of role pair combinations are obtained from the extracted list of roles, step 382 routes to step 363, wherein steps 342 and 382 are repeated for at least role pair combinations that have similarity that exceeds a floor or threshold. Once all role pairs have a generated similarity measure, role pairs are clustered by similarity in step 304 to identify similar role pairs. In step 324, clusters are utilized to build a cluster visualization illustrating the hierarchy of clusters. The cluster visualization is shown as part of a graphical user interface (GUI) with options for user interaction with the cluster visualization. Following the generation of a cluster visualization, step 344 makes available user selection of any cluster within the cluster visualization.

Upon user selection of a particular cluster, at a lower or higher level of the cluster hierarchy, step 364 drills down on the selected cluster. Role features associated with roles within the selected cluster are displayed in step 384. In one example, a selected cluster may be expanded into a list of all roles within the cluster. A list of associated features for each role may also be displayed, such as role members, role entitlements, or role supervisor. In another example, a single role within the selected cluster and one or more of the role's associated features are listed. In another example, a subset of two or more roles within the total plurality of roles within the selected cluster is analyzed based on role features. Flow diagram 300A may be executed a single time for a single role feature (e.g., membership) or repeated successively for multiple features (e.g., membership, followed by entitlement).

Next, a series of examples for specific role features are described. While this process may be implemented for a wide range of role features, this application focuses on the implementation of the technology disclosed for similarity measurement of role membership and role entitlements, respectively.

FIG. 3B shows a flow diagram 300B of a method for identifying similar members or users who each belong to a pair of roles, at the intersection of the two roles. A list of roles with associated membership lists is shown in 306, where each membership list contains one or more members corresponding to a particular role. Role one, with assigned membership list one, 326 can be obtained from the list of roles 306 as well as role two, with assigned membership list two, 327. A Venn diagram of the membership lists for role one 326 and role two 327 is shown, where the complement of role two membership 345 (i.e., role one members 326 that are not assigned to role two 327), the complement of role one membership 347 (i.e., role two members 327 that are not assigned to role one 326), and the intersection 346 of identical members between role one 326 and role two 327. Each respective intersection for a respective role pair becomes a data point in a hierarchical clustering output 366.

FIG. 3C shows a flow diagram 300C of a method for identifying similar members in the intersection of two roles. Flow diagram 300C differs from flow diagram 300B in that role entitlements are being compared instead of role membership. A list of roles with associated membership lists is shown in 306, where each membership list contains one or more members corresponding to a particular role. Role one, with assigned membership list one, 328 can be obtained from the list of roles 306 as well as role two, with assigned membership list two, 329. A Venn diagram of the membership lists for role one 328 and role two 329 is shown, where the complement of role two membership 348 (i.e., role one members 328 that are not assigned to role two 329), the complement of role one membership 350 (i.e., role two members 329 that are not assigned to role one 327), and the intersection 349 of identical members between role one 328 and role two 329. Each respective intersection for a respective role pair becomes a data point in a hierarchical clustering output 368.

### Role Features

The discussion now turns to a description of data structures corresponding to a particular role within an enterprise.

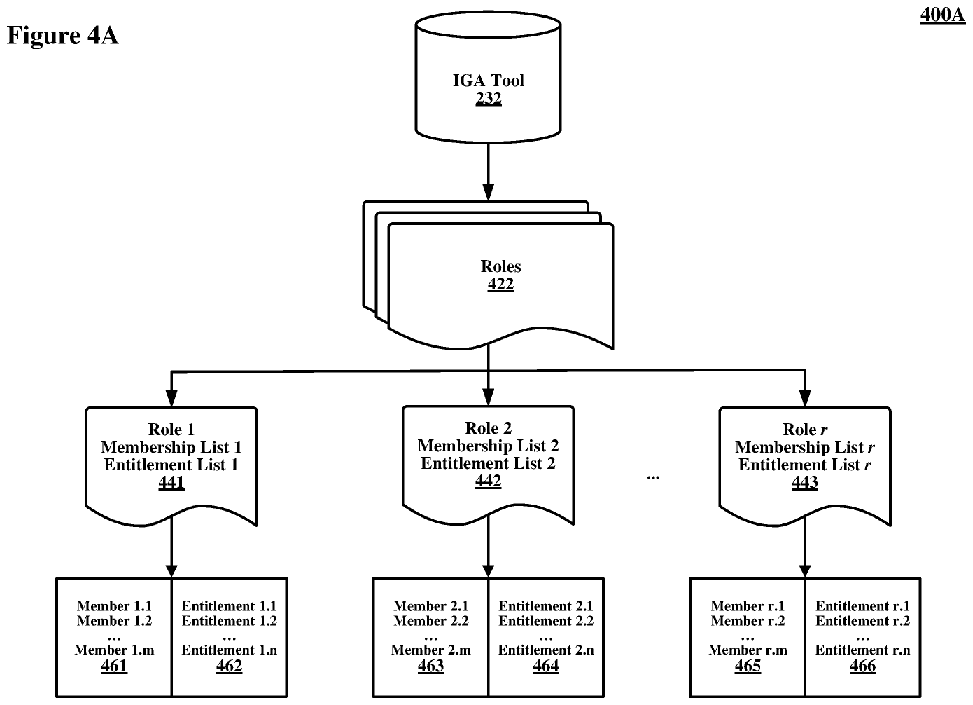

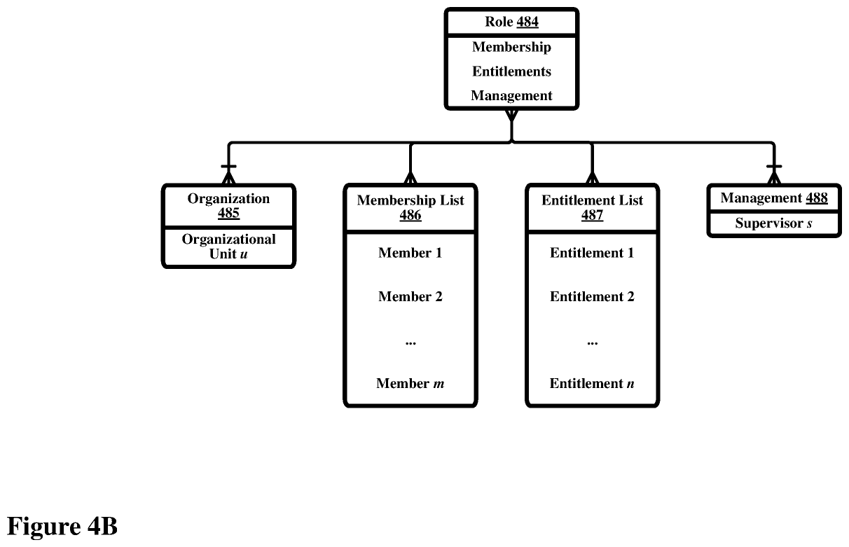

FIG. 4A illustrates the membership and entitlement features associated with a particular role. Again, membership refers to the users who are assigned to a particular role and entitlement refers to the access permissions a user receives upon assignment to a particular role. A plurality of roles 422 can be extracted from the identity governance and administration tool 232. Roles 422 comprise role one 411 through role r 443, each with their own respective assigned membership list and entitlement list. Additional role features may exist but are not shown in this diagram for the sake of clarity. Role one 441 has a corresponding membership list comprising members 1.1 through 1.m 461 and entitlements 1.1 through 1.n 462. Role two 442 has a corresponding membership list comprising members 2.1 through 2.m 463 and entitlements 2.1 through 2.n 464. Role r 443 has a corresponding membership list comprising members r.1 through r.m 465 and entitlements r.1 through r.n 466. Role one 441, role two 442, and role r 443 may have the same number of members (i.e., 1.m=2.m=r.m) or different numbers of members (i.e., 1.m≠2.m≠r.m, 1.m=2.m≠r.m, or 1.m≠2.m=r.m). Likewise, the same is also true for the number of entitlements.

FIG. 4B shows an entity relationship diagram 400B illustrating the structure and relationships of a role. First, each entity within the diagram will be described. Next, the relationships between the entities will be described.

A role 484 comprises attributes such as membership, entitlements, and management. A person skilled in the art will recognize that additional attributes of a role may exist and a limited number of example attributes are listed for clarity. An organization 485 comprises an attribute respective to organizational units (i.e., departments or teams within an enterprise). A membership list 486 comprises attributes for a plurality of members. An entitlement list 487 comprises attributes for a plurality of entitlements. A management entity 488 comprises attributes for at least one supervisor within the enterprise.

Role entities 484 generally have a many-to-at least one relationship with organization entities 485 (i.e., a plurality of roles can belong to a single department, but a particular role can belong to one or more departments). Role entities 484 generally have a many-to-many relationship with both membership lists 486 and entitlement lists 487 (i.e., multiple roles can share the same members and multiple members can share the same role). Role entities 484 generally have a many-to-at least one relationship with management entities 488 (i.e., multiple roles can share the same supervisor s or a plurality of supervisors).

While entity relationships 400B are described herein with reference to particular entities and relationships, it is to be understood that the entities are defined for convenience of description and are not intended to require a particular relationship between entities. Further, the entities need not correspond to physically distinct components.

Each association entity for a particular role 484 may be analyzed for similarity between a pair of roles. Thus far, the discussion has discussed an overview of a variety of similarity measures. Next, these similarity measures will be described in further detail.

### Similarity Measures

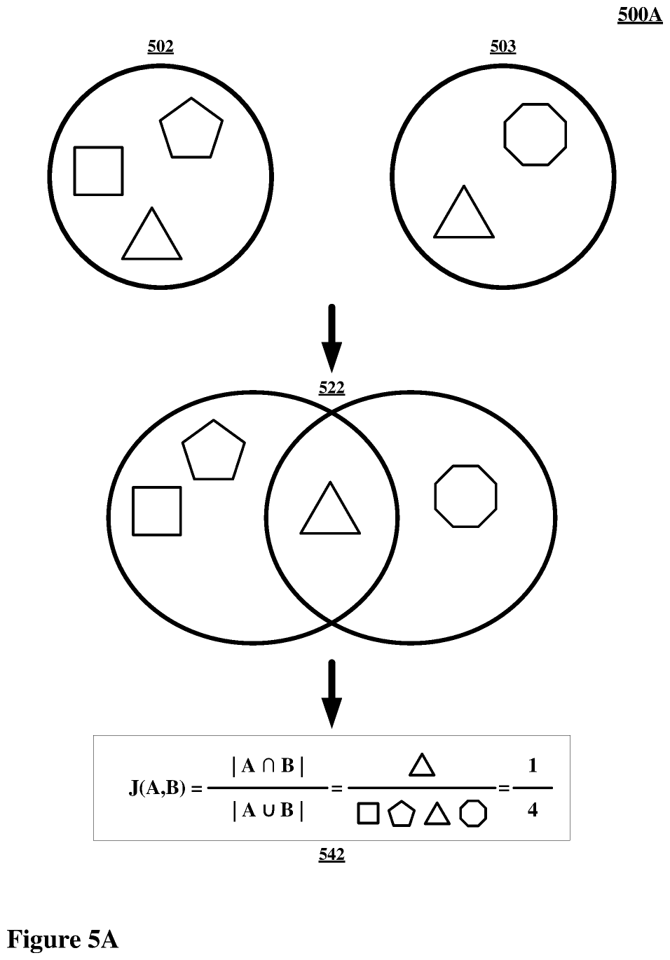

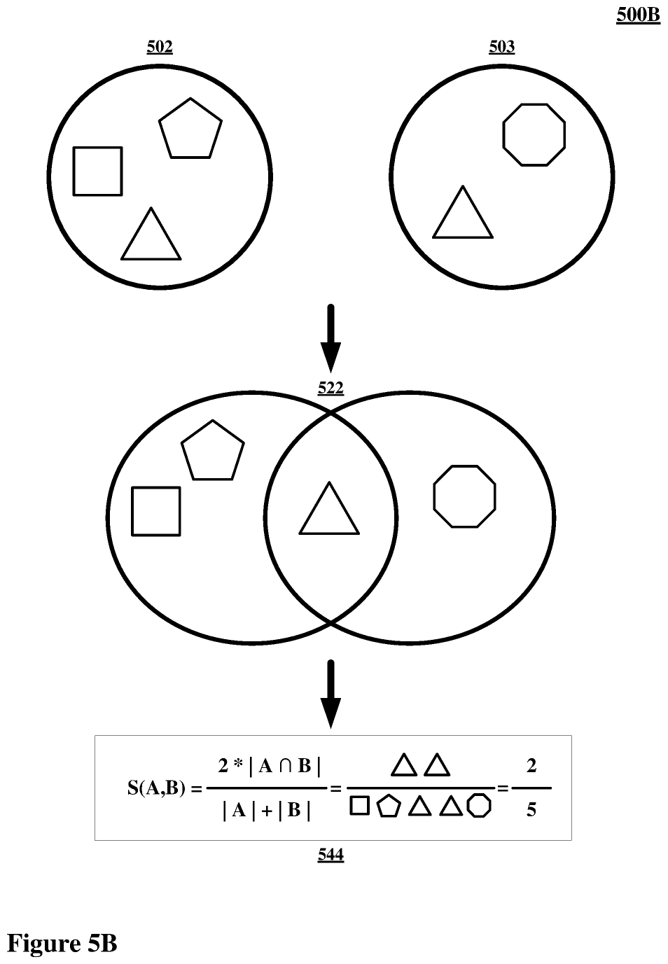

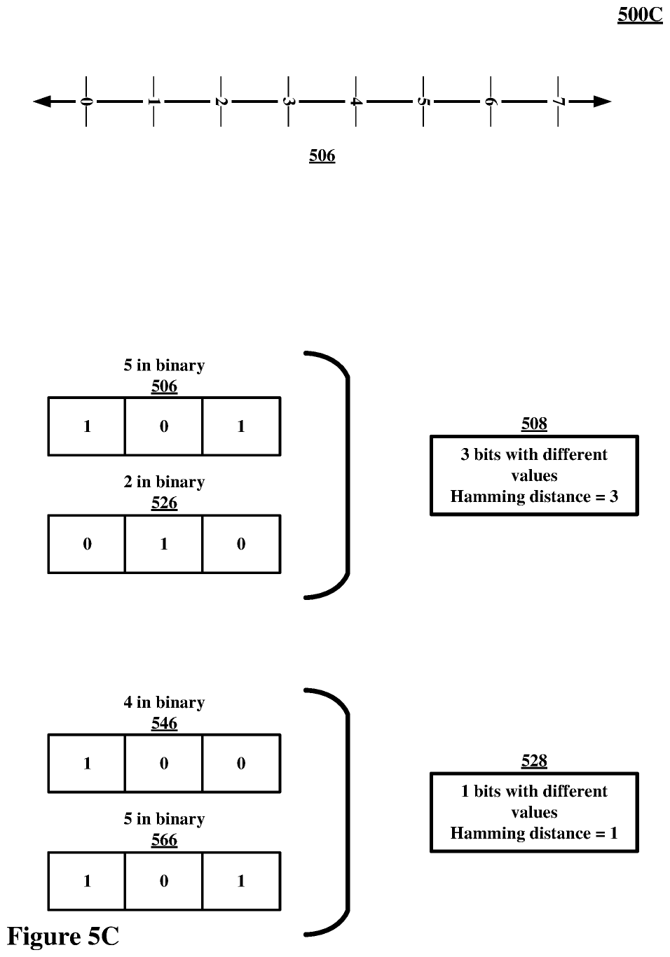

FIG. 5A illustrates an example calculation of the Jaccard similarity index. Entity 502 comprises three shapes, a pentagon, a square, and a triangle. Entity 503 comprises two shapes, an octagon, and a triangle. A Venn diagram 522 is generated to demonstrate the union, complement, and intersection of entity 502 and entity 503. The union of entity 502 and entity 503 comprises a square, a pentagon, a triangle, and an octagon. The complement of entity 502 comprises an octagon. The complement of entity 503 comprises a pentagon and a square. The intersection of entity 502 and entity 503 is a triangle. As shown in equation 542, the Jaccard similarity index is calculated as the intersection of two entities divided by the union of two entities. Thus, the Jaccard similarity of entity 502 and entity 503 is ¼.

FIG. 5B illustrates an example calculation of the Sorensen-Dice coefficient. Entity 502 and entity 503 are again shown with Venn diagram 522. Compared to the Jaccard similarity index, the Sorensen-Dice coefficient is calculated, as shown in equation 544, as two multiplied by the intersection divided by the sum of the complements of two entities. Thus, the Sorensen-Dice coefficient of entity 502 and entity 503 is ⅖.

Whereas illustrations 500A and 500B contrast similarity measures in terms of set theory, illustration 500C contrasts Euclidean distance with Hamming distance metrics. Real line 506 is a one-dimensional Euclidean space composed of real numbers. In Euclidean space, the distance between number five and number two (or number five and number four) is determined by the absolute distance between data points on the line. Compared to traditional Euclidean distance, Hamming distance measures the number of positions between two strings of equal length at which the corresponding values differ. Hamming distance is often described as the minimum number of errors (substitutions made within respective positions) to transform one string to another. String 506 is equivalent to 5 in binary, and string 526 equals 2 in binary. All three bits within the string are different values; hence, the Hamming distance 508 is three. String 546 is equal to 4 in binary, and string 566 is equal to 5 in binary. Only one bit within the string are different values; hence, the Hamming distance 528 is one.

### Data Visualization

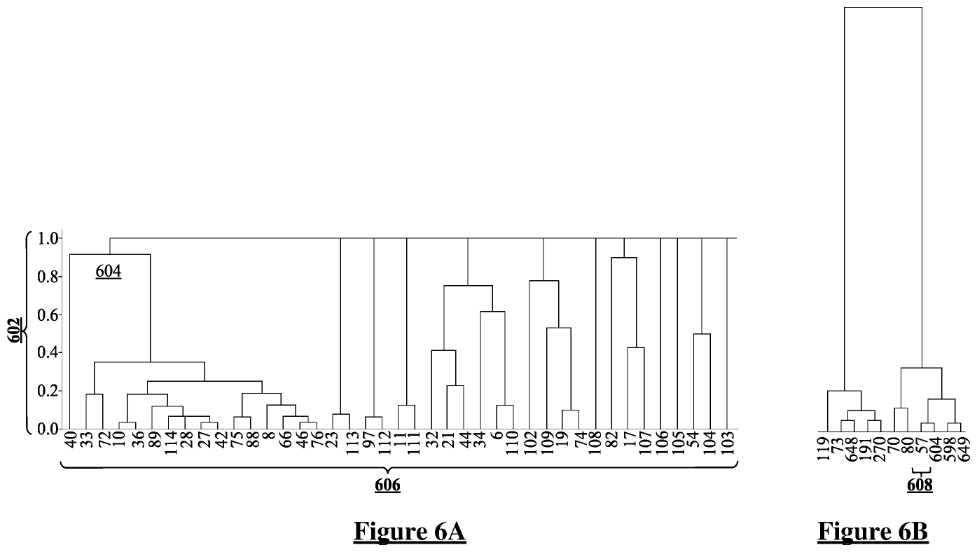

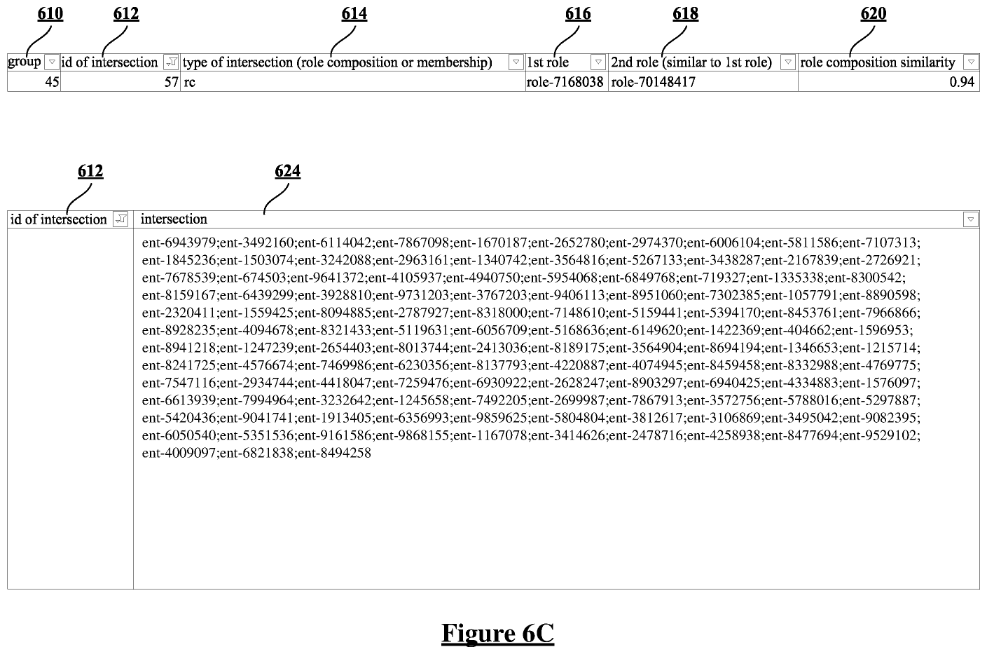

Now, an example process is described for the cluster visualization of a particular set of roles. For simplicity, only one form of cluster visualization is shown in the FIG. 6A-C dendrogram. FIG. 6A-C is an example dendrogram with an emphasized role pair. Two examples are shown in FIG. 7C.

FIG. 6A illustrates a hierarchical dendrogram generated from clustered role pair intersections. In this hierarchical dendrogram, leaves 606 represent multiple clusters of roles, descending from a shared branch 604 of common feature values. A hierarchy of branches 604 is typically several layers deep. Branch height is proportional to distance 602, as determined by Jaccard similarity. In other words, the closer a branch is, the more similar the roles contained within the attached leaves are, whereas more distant branches represent less similar roles within the attached leaves. In some implementations of the technology disclosed, each leaf represents a particular role cluster comprising a plurality of identical or similar roles. In other implementations, each leaf represents an individual role, such that roles within a particular cluster are connected to the same branch. A user, such as a security administrator, can interact with dendrogram 600A to identify candidate roles for coalescence as determined by distance. In many embodiments of the technology disclosed, roles below a predetermined distance threshold are coalesced, where greater distances in height between leaves correspond to greater dissimilarity between leaves.

FIG. 6B is a segment of a dendrogram with a few branches and leaves. Leaf 608 represents intersection 57.

For intersection 57, FIG. 6C displays subsets of data from the total similarity and clustering data. Fields 610-620 describe data associated with group identification number 45, where group 45 is a cluster within the plurality of clusters generated by hierarchical clustering, shown in the branch of FIG. 6B. Group 45 contains a plurality of intersections. Field 612 belongs to a column comprising intersection identification numbers, field 614 belongs to a column comprising type of intersection (membership, entitlements, etc.), field 616 belongs to a column comprising role identification numbers for a first role, field 618 belongs to a column comprising role identification numbers for a second role, and field 620 belongs to a column comprising similarity measures for the role pair within each respective row. Field 612 contains intersection identification number for intersection 57, belonging to group 45. Field 614 indicates that the similarity measure was calculated for role composition (where “role composition” is equivalent to entitlements). Fields 616 and 618 contain the role identification numbers for each role within the role pair, respectively. Field 620 is the Jaccard similarity for intersection 57, which is equal to 0.94. In further detail, field 624 lists all shared entitlements between the first role 616 and the second role 618 within intersection 57 612.

FIGS. 7A, 7B, 7C, and 7D contain components of an example graphical user interface (GUI) for role coalescence. FIG. 7A illustrates an example GUI for selection of roles within a role coalescence engine. 700A displays a dashboard for role coalescence engine 165, where a security administrator 202 is logged in to access an identity governance and administration tool 232. The security administrator 202, in addition to viewing previously imported roles and results from previous analyses, can import a new set of roles for analysis. Roles previously analyzed can be exported. The engine can be run with currently imported roles.

In response to the security administrator 202 selecting the ‘Import Roles’ function, the GUI presents a window for the user to upload a file (e.g., .CSV or .TXT file) comprising a list of roles and associated role features to be imported into identity governance and administration tool 232.

FIG. 7B illustrates an example graphical user interface for coalescence criteria, and an example role analysis, within a role coalescence engine. In 704B, the security administrator 202 can initiate a new role coalescence job using the system and methods described in FIGS. 2 and 3A. Many coalescence and filter criteria exist to modify the role coalescence engine 165, such as specific thresholds for membership and entitlement similarity (e.g., the security administrator 202 first specifies that roles should have at least 80% membership similarity, and within the set of roles that meet the membership similarity criteria, the security administrator 202 then specifies that the roles must also have at least 60% entitlement similarity to be considered for coalescence). The security administrator may also filter out certain roles, such as upper management positions. 706B illustrates an example of role comparison within the role coalescence engine GUI. The role comparison feature may be displayed in response to user exploration of imported roles, or results of a role coalescence engine job. In the shown example, two users are being compared for their memberships. In other implementations of the technology disclosed, the security administrator 202 may also examine a single role or compare more than two roles simultaneously.

FIG. 7C illustrates an example graphical user interface for example cluster visualizations within a role coalescence engine. 708C illustrates an example circle packing graph, wherein clusters are depicted as circles and circles are nested based on cluster hierarchy. In the shown example, let each smaller-sized circle (of which there are ten in total) correspond to a cluster of identical role pairs, and each larger circle (of which there are three) correspond to roles with a similarity above a given threshold (e.g., seventy, eighty, or ninety percent similarity or in a range of 70-99 or 80-100 percent or in a range bounded by the example thresholds). Thus, clusters of identical roles that possess non-identical features may still be clustered together at a less stringent similarity criteria within the hierarchy. In contrast, 710C illustrates an example dendrogram, wherein each leaf represents a particular role and each branch illustrates some degree of similarity between the connected roles. Branch distance from the terminal leaves is directly proportional to distance and inversely proportional to similarity. The security administrator 202 may select two or more roles to merge. The security administrator may view a dendrogram for similar roles, or a list of duplicate roles.

FIG. 7D illustrates an example graphical user interface for drilling down on a particular cluster within a cluster visualization. A first black rectangle identifies two particular clusters within a larger cluster in 704C, where the first black rectangle represents user selection. Likewise, a second black rectangle identifies two particular roles within the displayed cluster in 710C, where the second black rectangle also represents user selection. In response to user selection of a particular role or role cluster within either 708C or 710C, the user selection is drilled down on, resulting in the display of 706B. 706B displays a comparison of users associated with one overlapping role, Bank Manager. In some implementations of the technology disclosed, drilling down on a particular cluster or a particular role may result in display of a list of one or more users or one or more associated role features within the same cluster. In other implementations, drilling down on a particular cluster or a particular role may result in display of a list of one or more users or one or more associated role features within different clusters. In some implementations of the method, a user may select roles to coalesce from the display shown within 706B, while in other implementations, roles may be selected from the display shown in 708C or 710C.

The example GUI shown is shown in FIGS. 7A-D. It is to be understood that the diagrams are not intended to require a particular user interface nor to comprise a complete list of associated functions. The GUI may be altered to reflect any implementation described within the document, and a user skilled in the art will recognize additional arrangements of the GUI components. To the extent that physical distinct components are used, connections between components can be wired and/or wireless as desired. The different elements or components can be combined into single software modules and multiple software modules can run on the same hardware.

### Computer System

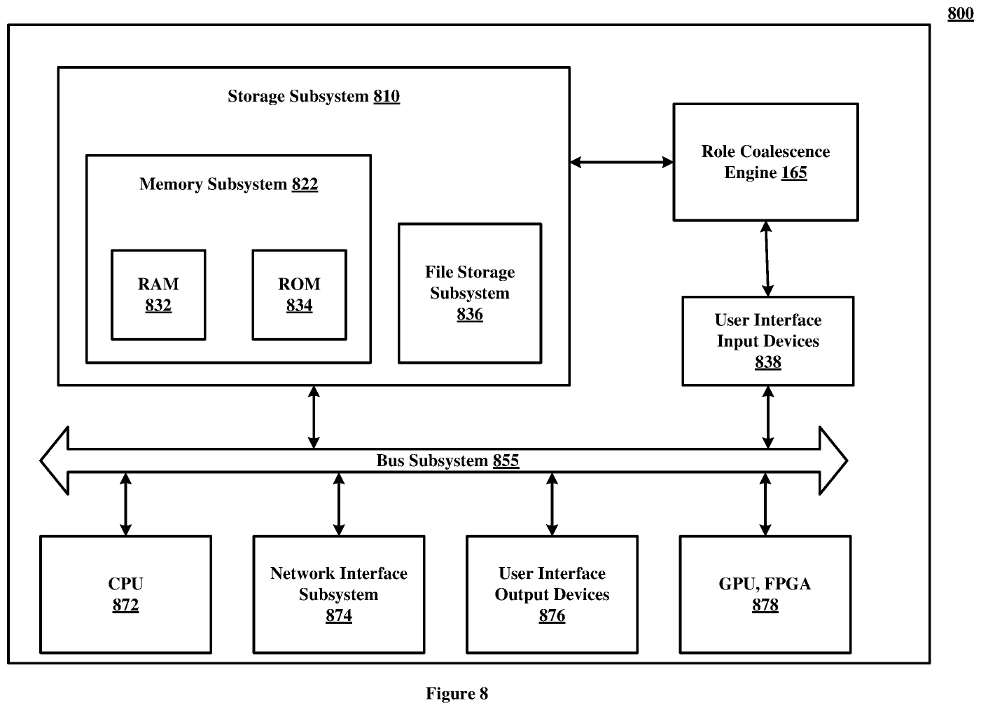

FIG. 8 is a simplified block diagram of a computer system 800 that can be used for role coalescence. Computer system 800 includes at least one central processing unit (CPU) 872 that communicates with a number of peripheral devices via bus subsystem 855, and Role Coalescence Engine 165, as described herein. These peripheral devices can include a storage subsystem 810 including, for example, memory devices and a file storage subsystem 836, user interface input devices 838, user interface output devices 876, and a network interface subsystem 874. The input and output devices allow user interaction with computer system 800. Network interface subsystem 874 provides an interface to outside networks, including an interface to corresponding interface devices in other computer systems. Access Control System 155 is communicably linked to the storage subsystem 810 and the user interface input devices 838.

User interface input devices 838 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 800.

User interface output devices 876 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 800 to the user or to another machine or computer system.

Storage subsystem 810 stores programming and data constructs that provide the functionality of some or all of the modules and methods described herein. Subsystem 878 can be graphics processing units (GPUs) or field-programmable gate arrays (FPGAs).

Memory subsystem 822 used in the storage subsystem 810 can include a number of memories including a main random-access memory (RAM) 832 for storage of instructions and data during program execution and a read only memory (ROM) 834 in which fixed instructions are stored. A file storage subsystem 836 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 836 in the storage subsystem 810, or in other machines accessible by the processor.

Bus subsystem 855 provides a mechanism for letting the various components and subsystems of computer system 800 communicate with each other as intended. Although bus subsystem 855 is shown schematically as a single bus, alternative implementations of the bus subsystem can use multiple busses.

Computer system 800 itself can be of varying types including a personal computer, a portable computer, a workstation, a computer terminal, a network computer, a television, a mainframe, a server farm, a widely distributed set of loosely networked computers, or any other data processing system or user device. Due to the ever changing nature of computers and networks, the description of computer system 800 depicted in FIG. 8 is intended only as a specific example for purposes of illustrating the preferred embodiments of the present invention. Many other configurations of computer system 800 are possible having more or fewer components than the computer system depicted in FIG. 8.

### Particular Implementations

We describe some implementations and features for a role coalescence engine in the following discussion.

One implementation discloses a method for identifying candidate roles to coalesce by effectively ranking similar roles as candidates. Roles are compiled from an identity governance and administration tool, and each respective role includes a plurality of role features. These role features may include attributes such as membership or entitlements. A similarity measure is determined for a pair of roles with respect to a single particular role feature, and the process is repeated iteratively for a plurality of role pairs within the compiled roles. The plurality of role pairs comprises each possible combination of a first and second role within the plurality of compiled roles. The plurality of role pairs is then clustered based on the similarity measure. A cluster visualization can be generated based on the clustered role pairs for display to a user. The displayed cluster visualization has controls for selecting a particular cluster within the cluster visualization. Upon receiving a signal indicating user selection of the particular cluster, the particular cluster is drilled down on to display at least one role feature corresponding to at least one role within the cluster.

In some implementations, the similarity measure can be computed for additional role features such as supervisor, organizational units, risk level, or session (i.e., a mapping between a user and a set of roles to which the user is assigned in the context of a working time).

The methods described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations.

One implementation of the method further includes the similarity measure being computed with respect to a membership list comprising members assigned to each respective role, for each respective role pair within the plurality of role pairs. Another implementation of the method further includes the similarity measure being computed with respect to an entitlement list comprising entitlements assigned to a respective role, for each respective role pair within the plurality of roles.

In some implementations of the method, the similarity measure is a Jaccard index. In other implementations, the similarity measure is a Hamming distance. In yet other implementations, the similarity measure is a Sorensen-Dice coefficient. A user skilled in the art will appreciate that these similarity measures are explicitly expressed as examples, and a range of other similarity measures exist that may be implemented within particular embodiments of the technology disclosed.

Some implementations of the method further include hierarchical clustering as the method of role pair clustering. Following clustering of the role pairs, cluster visualization may be implemented as a dendrogram in some embodiments. In this implementation of the method, dendrogram branches correspond to the hierarchy within the hierarchical clustering results. The height of any particular dendrogram branch is proportional to distance, where greater distances in height between branches correspond to greater dissimilarity. Roles below a predetermined distance threshold are coalesced. In some implementations, each dendrogram leaf may be respective to a particular cluster. In another implementation, each dendrogram leaf may be respective to a particular role pair. In yet another implementation, each dendrogram leaf may be respective to a particular role.

Other implementations of the technology disclosed further include a circle packing graph as the cluster visualization. In this implementation of the method, each circle corresponds to a particular cluster and circle nesting corresponds to the hierarchy within the hierarchical clustering results. Clusters above a predetermined size threshold are coalesced.

Other implementations of the method further include extracting candidate roles from an additional RBAC tool such as AIBAC. Some implementations include alternative clustering methods, such as K-means clustering, mean-shift clustering, Gaussian Mixture Models (GMM), or density-based special clustering of applications with noise (DBSCAN).

Other implementations of the disclosed technology described in this section can include a tangible non-transitory computer-readable storage media, including program instructions loaded into memory that, when executed on processors, cause the processors to perform any of the methods described above. Yet another implementation of the disclosed technology described in this section can include a system including memory and one or more processors operable to execute computer instructions, stored in the memory, to perform any of the methods described above.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

What is claimed is:

1. A computer-implemented method of identifying roles to coalesce, comprising:
compiling roles from an identity governance and administration tool, wherein each respective role includes a plurality of role features;
repeatedly computing a similarity measure between a pair of roles with respect to a particular role feature;
clustering a plurality of role pairs based on the similarity measure;
generating a cluster visualization based on the clustered role pairs;
causing display of the cluster visualization to a user with controls for selecting a particular cluster of the cluster visualization;
receiving a signal indicating a user selection of the particular cluster;
drilling down on the particular cluster in response to a user selection and displaying at least one role feature corresponding to at least one role within the cluster; and
receiving a signal indicating the user selection to coalesce two or more roles within the cluster.

2. The computer-implemented method of claim 1, further including a first role feature that is a membership list comprising members assigned to a respective role, wherein the similarity measure is computed with respect to the first role feature.

3. The computer-implemented method of claim 1, further including a second role feature that is an entitlement list comprising entitlements assigned to a respective role, wherein the similarity measure is computed with respect to the second role feature.

4. The computer-implemented method of claim 1, wherein the similarity measure is a Jaccard index, a Hamming distance, or a Sorensen-Dice coefficient.

5. The computer-implemented method of claim 1, wherein the plurality of role pairs are clustered using hierarchical clustering.

6. The computer-implemented method of claim 5, wherein the cluster visualization is a dendrogram and dendrogram branches correspond to a hierarchy within the hierarchical clustering.

7. The computer-implemented method of claim 6, wherein a dendrogram leaf represents a particular cluster.

8. The computer-implemented method of claim 7, wherein a dendrogram leaf represents a particular role.

9. The computer-implemented method of claim 8, wherein height is proportional to distance and greater distances in height between branches correspond to greater dissimilarity between leaves.

10. The computer-implemented method of claim 9, wherein roles below a predetermined distance threshold are coalesced.

11. The computer-implemented method of claim 5, wherein the cluster visualization is a circle packing graph and each circle corresponds to a particular cluster.

12. The computer-implemented method of claim 11, wherein circle nesting corresponds to a hierarchy within the hierarchical clustering.

13. The computer-implemented method of claim 12, wherein clusters above a predetermined circle size threshold are coalesced.

14. A tangible non-transitory computer-readable storage media, including program instructions loaded into memory that, when executed on processors, cause the processors to implement a method of identifying roles to coalesce, the method including:
compiling roles from an identity governance and administration tool, wherein each respective role includes a plurality of role features;
repeatedly computing a similarity measure between a pair of roles with respect to a particular role feature;
clustering a plurality of role pairs based on the similarity measure;
generating a cluster visualization based on the clustered role pairs;
causing display of the cluster visualization to a user with controls for selecting a particular cluster of the cluster visualization;
receiving a signal indicating a user selection of the particular cluster;
drilling down on the particular cluster in response to a user selection and displaying at least one role feature corresponding to at least one role within the cluster; and
receiving a signal indicating the user selection to coalesce two or more roles within the cluster.

15. The non-transitory computer-readable storage media of claim 14, further including a first role feature that is a membership list comprising members assigned to a respective role, wherein the similarity measure is computed with respect to the first role feature.

16. The non-transitory computer-readable storage media of claim 14, further including a second role feature that is an entitlement list comprising entitlements assigned to a respective role, wherein the similarity measure is computed with respect to the second role feature.

17. The non-transitory computer-readable storage media of claim 14, wherein the plurality of role pairs are clustered using hierarchical clustering.

18. The non-transitory computer-readable storage media of claim 17, wherein clusters above a predetermined similarity or distance threshold are coalesced.

19. A system for identifying roles to coalesce, the system including a processor, memory coupled to the processor and program instructions from the non-transitory computer-readable storage media of claim 14 loaded into the memory.

20. The system of claim 19, further including a first role feature that is a membership list comprising members assigned to a respective role, wherein the similarity measure is computed with respect to the first role feature.

21. The system of claim 19, further including a second role feature that is an entitlement list comprising entitlements assigned to a respective role, wherein the similarity measure is computed with respect to the second role feature.

22. The system of claim 19, wherein the plurality of role pairs are clustered using hierarchical clustering.

23. The system of claim 22, wherein roles below a predetermined similarity or distance threshold are coalesced.
